(19) United States
(12) Patent Application Publication
(10) Pub. No.: US 2026/0041062 A1
(43) Pub. Date: Feb. 12, 2026

(54) ANIMAL WASTE COLLECTION BAG

(71) Applicant: Matthew Muscarella, Oradell, NJ (US)

(72) Inventor: Matthew Muscarella, Oradell, NJ (US)

(21) Appl. No.: 18/797,161

(22) Filed: Aug. 7, 2024

(51) Int. Cl. B65F 1/00; A01K 13/00

(52) U.S. Cl. CPC A01K 23/005; A01K 13/001; B65F 1/0006; B65F 2240/136

(57) ABSTRACT

A waste collection apparatus for cleaning an animal after defecation and collecting feces dropped by the animal includes a bag which has a closed end and an open end and which defines an interior space therein. The bag comprises a pliable material and is sized and configured to accommodate a hand of a user therein. A wipe is mounted on an exterior surface of the bag.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to waste containers and more particularly pertains to a new waste container for cleaning an animal after defecation and collecting feces dropped by the animal.

### (2) Description of Related Art Including Information Disclosed Under 37 CFR 1.97 and 1.98

The prior art discloses various waste bags, including those which include a wipe attached to the bag for cleaning and sanitizing an animal after it defecates. However, the prior art fails to disclose such an apparatus in which the wipe has a semi-circular shape and which is positioned to cover a user's hand when the user inserts their hand into the bag.

### BRIEF SUMMARY OF THE INVENTION

An embodiment of the disclosure meets the needs presented above by generally comprising a bag which has a closed end and an open end and which defines an interior space therein. The bag comprises a pliable material and is sized and configured to accommodate a hand of a user therein. A wipe is mounted on an exterior surface of the bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of a waste collection apparatus according to an embodiment of the disclosure.

FIG. 2 is a front view of an embodiment of the disclosure.

FIG. 3 is a cross section view of an embodiment of the disclosure taken from Line 3-3 in FIG. 2.

FIG. 4 is an in-use view of an embodiment of the disclosure in which a user has inserted their hand into a bag and cleans an animal after it has defecated.

FIG. 5 is an in-use view of an embodiment of the disclosure in which the bag is everted to encapsulate a quantity of feces.

### DETAILED DESCRIPTION OF THE INVENTION

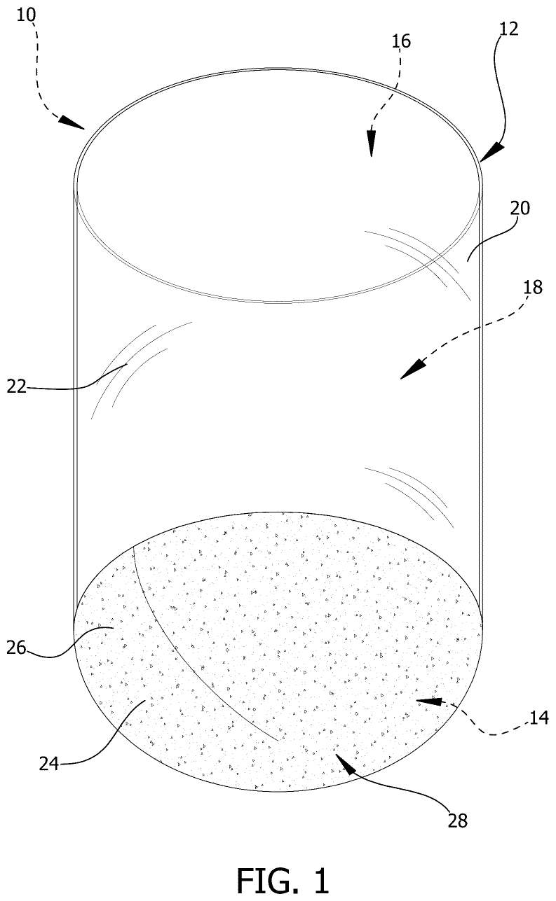

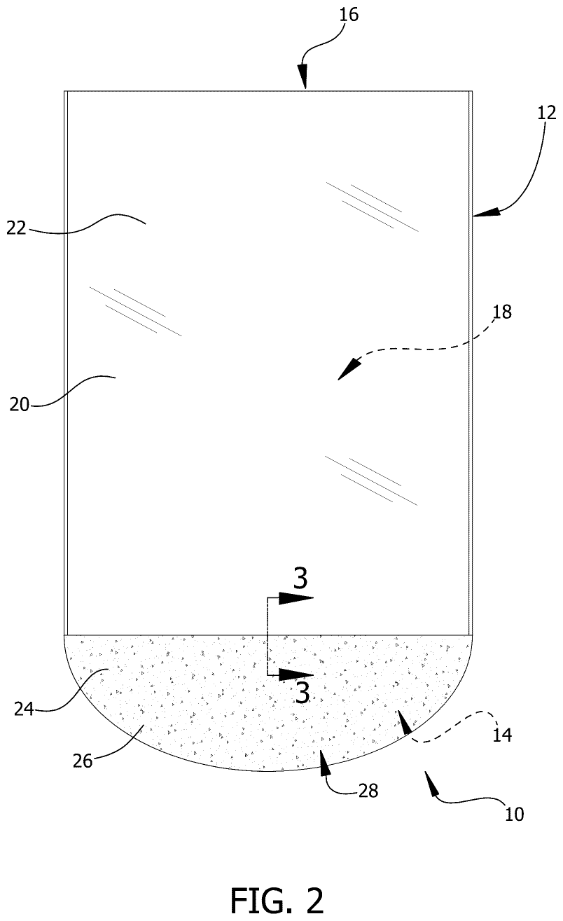

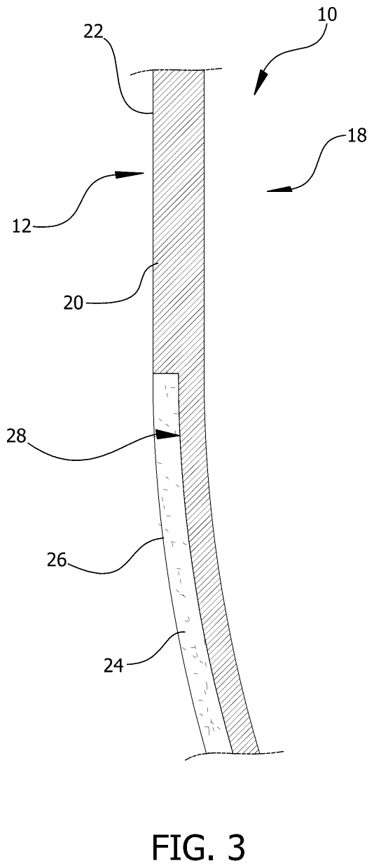

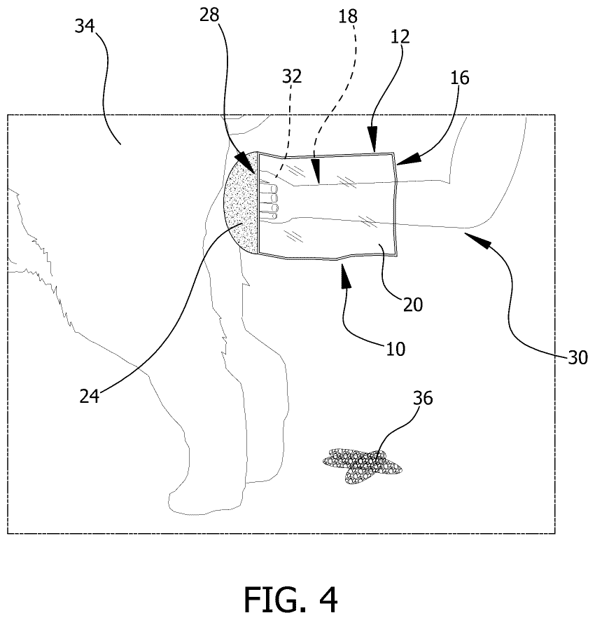

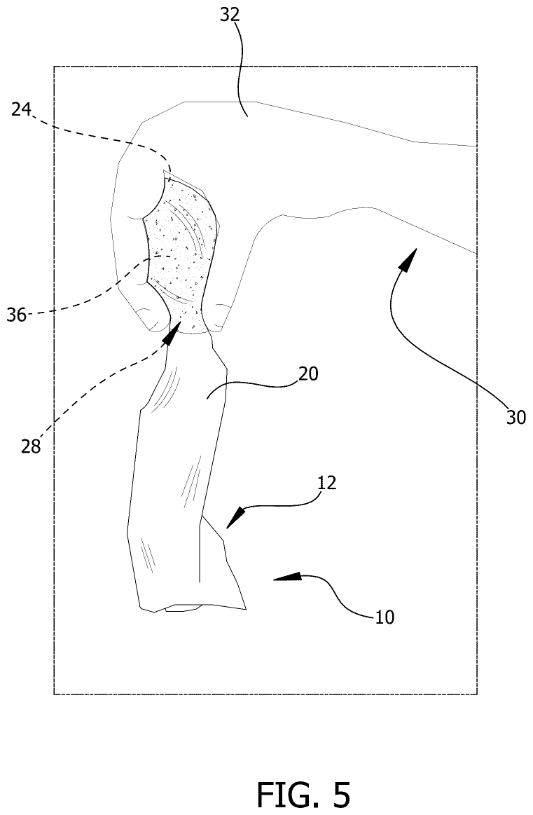

With reference now to the drawings, and in particular to FIGS. 1 through 5 thereof, a new waste container embodying the principles and concepts of an embodiment of the disclosure and generally designated by the reference numeral 10 will be described.

As best illustrated in FIGS. 1 through 5, the waste collection apparatus 10 generally comprises a bag 12 which has a closed end 14 and an open end 16, the bag 12 defining an interior space 18 therein. The bag 12 comprises a pliable material which is fluid impermeable. The bag 12 is sized and configured to accommodate a hand 32 of a user 30 therein. The bag 12 comprises a tube section 20 which is cylindrical and extends from the open end 16 toward the closed end 14. The closed end 14 has a semi-spherical shape. The pliable material may be a plastic material or other film, paper, or suitably pliant material. The pliable material may be transparent in some embodiments. The pliable material may have a uniform thickness throughout the tube section 20. The bag 12 also may have other tubular shapes between the open end 16 and the closed end 14.

A wipe 24 is coupled to an exterior of the bag 12 at the closed end 14. The wipe 24 has a semi-spherical shape which conforms to the semi-spherical shape of the closed end 14 of the bag 12. An external surface 26 of the wipe 24 forms a continuous face with an outer surface 22 of the tube section 20 of the bag 12. The wipe 24 comprises an absorbent material such as a fabric formed of cotton, polyester, polypropylene, or the like. The wipe 24 contains a fluid 28 which may facilitate cleaning or sanitizing surfaces. The fluid 28 may comprise water, isopropyl alcohol, a surfactant, a sanitizer, a lotion, a perfume, or the like.

In use, the user 30 may insert their hand 32 into the interior space 18 of the bag 12 such that the wipe 24 surrounds the hand 32. The user 30 may then apply the wipe 24 to the anus and surrounding areas of an animal 34 which has recently defecated to clean the animal 34. Depending on the substances embedded in the wipe 24, the user 30 may also sanitize, deodorize, or otherwise treat the areas of the animal 34. The user 30 may then pick up feces 36 dropped by the animal 34 by using the bag 12 and wipe 24 to protect the user 30's hand 32 from direct contact with the feces 36. In particular, the fluid impermeability of the pliable material of the bag 12 prevents moisture from leaking through the bag 12. The bag 12 may then be everted to encapsulate the feces 36. The bag 12 may be twisted, tied, or otherwise closed to secure the feces 36 in the everted bag 12, which may then be disposed of.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A waste collection apparatus comprising:
a bag having a closed end and an open end, the bag defining an interior space therein, the bag comprising a pliable material, the bag being sized and configured to accommodate a hand of a user therein; and
a wipe coupled to the bag, the wipe being positioned on an exterior surface of the bag;
wherein the closed end has a semi-spherical shape; and
wherein the wipe is positioned on the closed end of the bag, wherein the wipe has a semi-spherical shape having a curved edge being coextensive with the closed end.

2. The waste collection apparatus of claim 1, wherein the bag comprises a tubular section which extends from the open end toward the closed end.

3. The waste collection apparatus of claim 2, wherein the tubular section has a cylindrical shape.

4. (canceled)

5. (canceled)

6. The waste collection apparatus of claim 1, wherein the pliable material is fluid impermeable.

7. The waste collection apparatus of claim 1, wherein the wipe comprises an absorbent material.

8. The waste collection apparatus of claim 7, further comprising a fluid embedded in the wipe.

9. A waste collection apparatus comprising:
a bag having a closed end and an open end, the bag defining an interior space therein, the bag comprising a pliable material, the bag being sized and configured to accommodate a hand of a user therein, the bag comprising a tubular section which extends from the open end toward the closed end, the tubular section having a cylindrical shape, the closed end having a semi-spherical shape, the pliable material being fluid impermeable;
a wipe coupled to the bag, the wipe being positioned on an exterior surface of the bag, the wipe comprising an absorbent material, the wipe being positioned on the closed end of the bag, the wipe having a semi-spherical shape having a curved edge being coextensive with the closed end; and
a fluid embedded in the wipe.
